(19) United States
(12) Patent Application Publication
(10) Pub. No.: US 2008/0137500 A1
(43) Pub. Date: Jun. 12, 2008

(54) Method and apparatus for controlling the movement of a head in a disk drive

(75) Inventor: Makoto Asakura, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/980,449

(22) Filed: Oct. 31, 2007

(30) Foreign Application Priority Data
Dec. 7, 2006 (JP) 2006-330945

(51) Int. Cl. G11B 5/58

(52) U.S. Cl. 369/53.17

(57) ABSTRACT

According to one embodiment, a disk drive having a head-motion control system. The disk drive comprises a defect evading unit. The defect evading unit includes a defect-approach determining unit and an evasion-orbit defining unit. The defect-approach determining unit determines a position near a defective part, which the head is approaching, on the basis of defect position information. The evasion-orbit defining unit changes the motion orbit of the head on the basis of the position determined by the defect-approach determining unit, thereby making the head evade the defective part.

### CROSS-REFERENCE TO RELATED APPLICATIONS

This application is based upon and claims the benefit of priority from Japanese Patent Application No. 2006-330945, filed Dec. 7, 2006, the entire contents of which are incorporated herein by reference.

### BACKGROUND

1. Field

One embodiment of the present invention relates to a hard disk drive. More particularly, the invention relates to a technique of controlling the movement of a head in order not to use the defective parts of a disk medium.

2. Description of the Related Art

Most disk drives, a representative example of which is a hard disk drive, incorporate a head-positioning control system (hereinafter referred to as servo system) that moves each head to a target position (i.e., target track or target cylinder) on a disk medium and positions the head at the target position. At the target position, the head can write and read data on and from the disk medium.

The servo system controls the head positioning in accordance with the servo data recording on the disk medium. The servo data contains address codes and servo-burst patterns. The address codes represent the addresses of the tracks or cylinders provided on the disk medium. The servo-burst patterns are used to detect the positions in each track. Usually, the servo system performs a seeking operation and a tracking operation. The seeking operation is to move the head to a desired position, or a desired track. The tracking operation (track tracing) is to position the head in the desired track.

The disk medium may have defects such as protrusions due to impacts applied to it during the manufacture of the disk drive or after the disk drive has been shipped. Any head of a disk drive may contact such a defect since the head is spaced a very short distance from the surface of the disk medium while it is moving and floating over the disk medium. If the head contacts a defect, post defects may develop on the disk medium. The post defect may enlarge or may cause the head to malfunction, depending on its magnitude.

To solve this problem, a technique has been proposed (see, for example, Jpn. Pat. Appln. KOKAI Publication No. 2003-308667). This technique is to change the speed at which the head is moved, in accordance whether the head is accelerated, moved at a constant speed or decelerated during the seeking operation, if any protrusion exists in the seek locus (locus of the moving head) extending to the desired position.

If defects such as projections exist on the disk medium, they may result in post defects. To prevent such an event from taking place, a technique of changing the speed of the operation has been proposed. However, this technique cannot be said to be an effective measure for preventing post defects.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the major components of a servo system according to an embodiment of the present invention;

FIG. 2 is a block diagram showing the major components of a disk drive according to the embodiment;

FIG. 3 is a block diagram showing the basic configuration of the servo system according to the embodiment;

FIG. 4 is a block diagram explaining how the servo system according the embodiment controls the seeking operation;

FIG. 5 is a graph illustrating seeking orbit, explaining how defects are prevented from developing in the embodiment;

FIG. 6 is a graph explaining the principle of the technique of avoiding defects in the embodiment;

FIGS. 7A and 7B are other graphs explaining the principle of the technique of avoiding defects in the embodiment;

FIG. 8 is a block diagram showing the target-orbit defining unit according to the embodiment;

FIG. 9 is a block a block diagram showing a target-orbit defining unit according to another embodiment of the present invention; and

FIG. 10 is another block diagram showing the target-orbit defining unit according to the other embodiment.

### DETAILED DESCRIPTION

Various embodiments according to the invention will be described hereinafter with reference to the accompanying drawings. In general, according to one embodiment of the invention, there is provided a disk drive in which each head is controlled not to move over defects, if any on a disk medium, thereby preventing post defect from developing or expanding.

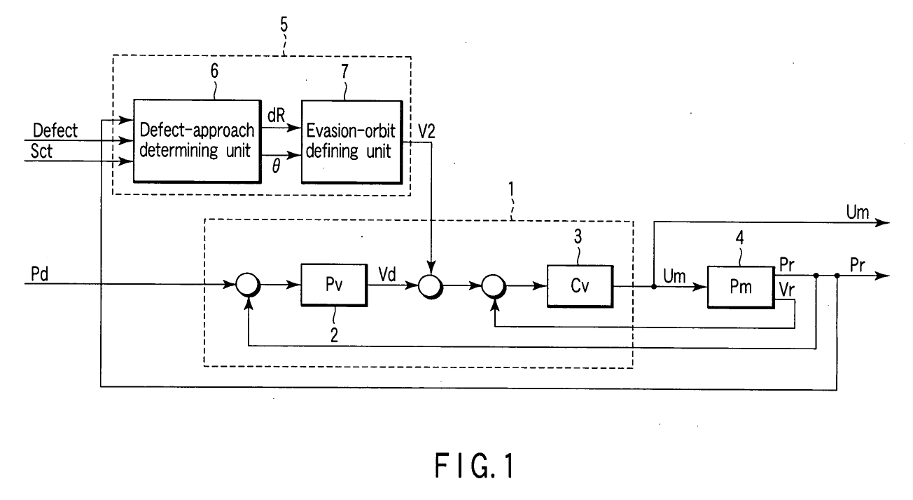

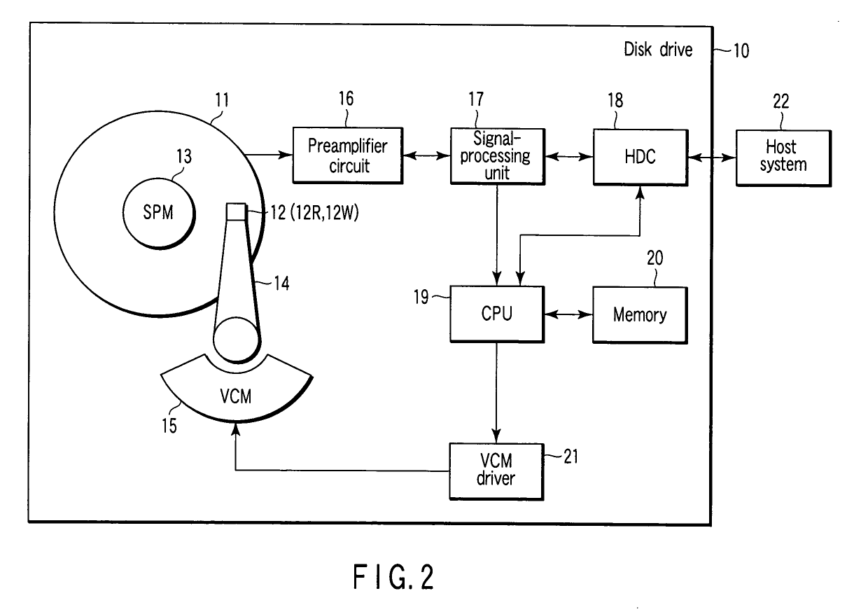

According to an embodiment, FIG. 1 shows a block diagram showing the major components of a servo system. FIG. 2 is a block diagram showing the major components of a disk drive according to the embodiment.

(Configuration of the Disk Drive)

As shown in FIG. 2, the disk drive 10 according to the embodiment has a disk medium 11, a head 12, and a spindle motor (SPM) 13. The disk medium 11 is a magnetic recording medium. The spindle motor 13 can rotate the disk medium 11. Servo data is recorded on the disk medium 11. The servo data is used in the head-positioning control performed by a servo system, which will be described later. The servo data contains address codes and servo-burst data patterns. Each address code represents the address of a track or cylinder. Each servo-burst pattern is used to detect the position the head takes in a track.

The head 12 is mounted on an actuator 14 that can be driven by a voice coil motor (VCM) 15. The head 12 includes a read head 12R and a write head 12W. The read head 12R can read data from the disk medium 11. The write head 12W can write data on the disk medium 11.

The VCM 15 is supplied with a drive current from a VCM driver 21 and is driven and controlled. The actuator 14 is a head-moving mechanism that is driven and controlled by a microprocessor (CPU) 19, which is the main element of a servo system that will be described later. When controlled by the servo system, the actuator 14 moves the head 12 to, and positions the same, at a desired position (desired track or desired cylinder) on the disk medium 11.

The disk drive 10 has a preamplifier circuit 16, a signal-processing unit 17, a disk controller (HDC) 18, a CPU 19 and a memory 20, in addition to the head-disk assembly described above. The preamplifier circuit 16 has a read amplifier and a write amplifier. The read amplifier amplifies the read-data signal output from the read head 12R. The write amplifier supplies a write-data signal to the write head 12W.

The signal-processing unit 17 is a unit that processes a read/write read-data signal (including a servo signal corresponding to servo data). Thus, it is also known as a “read/write channel.” A read-data signal and a write-data signal contain not only a signal corresponding to the user data, but also a servo signal corresponding to the servo data. The signal-processing unit 17 includes a servo decoder that reproduces servo data from a servo signal.

The HDC 18 can function as an interface between the disk drive 10 and a host system 22 (e.g., personal computer or any one of various digital apparatuses). The HDC 18 performs the transfer of read data and write data between the disk medium 11 and the host system 22.

The CPU 19 is the main controller in the disk drive 10 and the main element of the servo system according to the present embodiment. The CPU 19 performs the head-positioning control. The memory 20 includes a RAM and a ROM, in addition to a flash memory (EEPROM, i.e., a nonvolatile memory). It stores various data items and programs that control the CPU 19.

(Servo System)

The servo system is constituted by servo decoders provided in the CPU 19 and the signal-processing unit 17. The servo system performs a seeking operation to move the head 12 to a desired position, and a tracking operation (track tracing) to position the head 12 at a desired position in a track. The servo system according to this embodiment has the function of moving the head 12, causing the head 12 not to pass over defects, if any, on the disk medium 11.

The function of the servo system according to this embodiment will be described, with reference to FIGS. 1, 3 and 4.

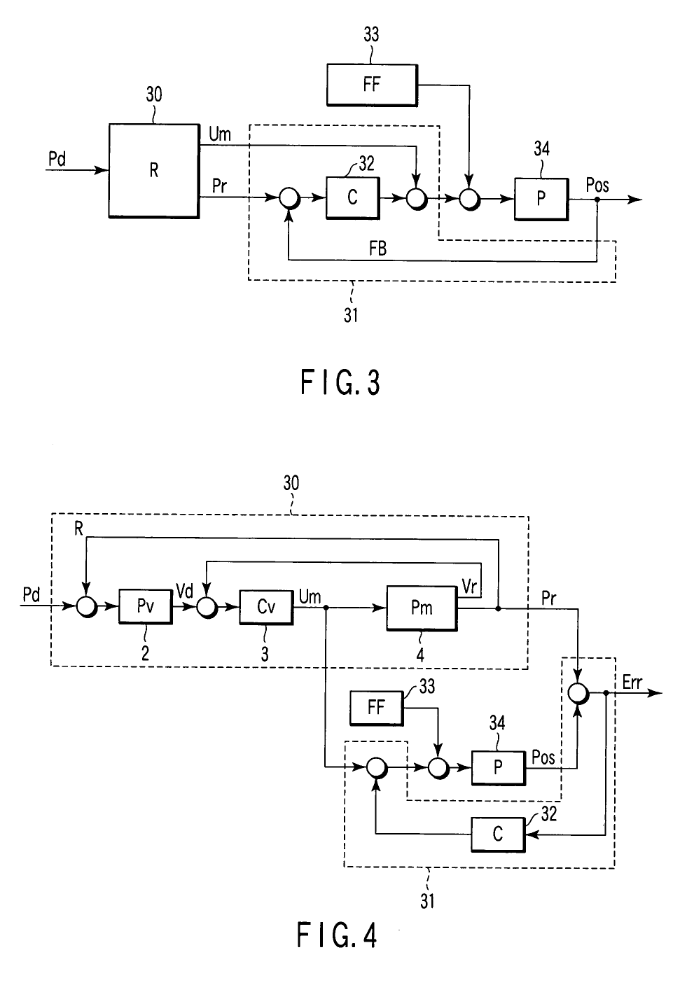

As shown in FIG. 3, the servo system has a target-orbit defining unit (R) 30, a model-following control unit (FB) 31, a low-degree RRO-suppression compensating unit (FF) 33, and a head drive system (P) 34. This servo system is a model-following system. It is basically configured to perform a seeking operation and a tracking operating, achieving a servo control so that the head position Pos may coincide with a target position (model position). The model position, to which the head should is moved, corresponds to a desired position Pd.

The model-following control unit 31 has a feedback control unit (C) 32. The unit 31 generates a command that instructs the head drive system 34 to move the head 12 so that the head position Pos may follow the target orbit defined by the target-orbit defining unit (R) 30. The head drive system 34 is the actuator 14 that has the VCM 15. In a narrow sense of the term, the system 34 is the VCM 15.

The target-orbit defining unit 30 generates a target-position orbit Pr and a model input value Um (model-drive command value). The data representing the orbit Pr and the model input value Um are output to the model-following control unit 31. During the tracking operation, the target-orbit defining unit 30 sets the target-position orbit Pr to a fixed value and sets the model input value Um to zero. When the desired position Pd to which the head should be moved changes and the operation is thereby changed to the seeking operation, the target-orbit defining unit 30 generates a target-position orbit Pr and a model input value Um, which achieve a stable transition operation. The model input value Um is a drive command that makes the head position Pos lie in the target-position orbit Pr if there is no disturbance that affects the head drive system 34.

The low-degree RRO-suppression compensating unit 33 generates a feed-forward amount (compensation value FF) that compensates for a large repeatable runout (RRO) resulting from a track deviation that is synchronous with the rotation of the spindle motor 13. The feed-forward amount can prevent any decrease in the precision of the positioning the controller 32 performs and can also suppress the apparent disturbance affecting the head drive system 34.

FIG. 4 is a block diagram explaining how the seeking operation is controlled to move the head from the present position Pos (equivalent to the model position Pr) to the desired position Pd.

As shown in FIG. 4, the target-orbit defining unit 30 has a speed-profile generating unit 2, a speed control unit 3, and a virtual control mode 4. The target-orbit defining unit 30 generates a target position orbit (model position) Pr that accords with the desired position Pd. The speed-profile generating unit 2 is configured to generate data representing a desired speed at which the head drive system 34 should drive the head 12. More precisely, the unit 2 generates data representing the desired speed Vd, from the data showing the deviation of the present value Pr (or the present position Pos). The speed-profile generating unit 2 is an element that performs, for example, limited proportioning and differentiation (PD).

The speed control unit 3 generates a model input value Um from the present model speed Vr (or speed data inferred from the present position Pos). The speed control unit 3 is, for example, a unit for stabilizing the PD operation and compensating for the PD operation.

The model to be controlled 4 (i.e., virtual model) Pm 4 is a nominal model of the head drive system 34, as in most cases. The model input value Um drives the virtual model 4 and the head drive system 34 at the same time. The virtual model (Pm) may completely identical to the head drive system 34 and the disturbance may be negligibly small. Then, the head position Pos will be identical to the model position Pr. In practice, however, a model error exists and the disturbance is not negligibly small, and the position error is never zero. Therefore, the feedback control unit (C) 32 corrects the model input value Um in order to compensate for this error. Thus, the virtual model (Pm) 4 performs a continuous, stable transition operation. This enables the target-orbit defining unit 30 to generate a target position orbit Pr that leads the head 12 to the desired position Pd.

The seeking control described above is applied, particularly to a long-distance seeking operation. Nonetheless, the seeking control can be applied to a short-distance seeking operation, too, by a model-following control system. During the short-distance seeking operation, however, the speed profile for this operation is set to a steep multi-degree one that is close to the response-characteristic limit, and the model input value Um and the target position orbit Pr are associated in a table beforehand. The table is referred to, thereby to shorten the operation time and improve the response characteristic. During the long-distance seeking control, the model input value Um is a drive command similar to one used in the bang-bang control (on/off control) and is generated with reference to the table. Nevertheless, the seeking model can be regarded as having been calculated before the value Um is so generated.

FIG. 1 is a block diagram showing the major components of the servo system that characterizes the present embodiment. The servo system according to this embodiment is constituted by adding a defect evading unit 5 to the target-orbit defining unit 30 shown in FIGS. 3 and 4. Thus, the servo system is a seeking control system of model-following type and has a speed control system 1 and a model 4 to control (i.e., virtual mode Pm). The speed control system 1 includes the speed-profile generating unit 2 and the speed control unit 3.

The defect evading unit 5 has a defect-approach determining unit 6 and an evasion-orbit defining unit 7. The defect evading unit 5 refers to map information (Defect) that manages the defect position information (defect information) representing the positions of fatal defective units (defective sectors) registered in, for example, the memory 20. By referring to the map information, the defect evading unit 5 generates a correction amount V2 that makes the virtual model position Pr evade the defective units. The correction amount V2 is a speed value by which the desired seeking speed should be corrected in order to accomplish the defect evasion.

The target-orbit defining unit 30 applies the correction amount V2, correcting the desired speed Vd generated by the speed-profile generating unit (Pv) 2. The speed control unit (Cv) 3 therefore outputs a model input value (model-drive command value) Um.

The map information (Defect) contains data that represents, for example, the degree of the defects. This information is converted to the addresses of the servo sectors and tracks, where the defects exist. These addresses are registered as table information in, for example, the memory 20 or the disk medium 11.

The defect-approach determining unit 6 extracts the defect position information about the detect existing near or nearest the present position of the head 12, with respect to the seeking direction. More specifically, the defect-approach determining unit 6 extracts the defect position information in accordance with the present position Pr of the model and the present servo-sector information (sector address Sct).

From the defect position information thus extracted, the defect-approach determining unit 6 calculates an inter-defective sector radius dR (track difference) and an inter-defective sector phase θ (sector difference). The inter-defective sector radius dR is the distance to the track at which a defect (defective sector) lies. The inter-defective sector phase θ corresponds to a circumferential distance to the defective sector.

The defect-approach determining unit 6 extracts the next defect position information, not immediately after the head 12 passes over the track having the defective sector, but after the head 12 passes over a tolerant number of tracks. The inter-defective defective sector phase θ is a complete servo sector difference and is output as an integer value pertaining to the distance between +1/2 servo sector and −1/2 servo sector. The information output from the defect-approach determining unit 6 may be any information that results in a value corresponds to the distance between the defective sector and the locus not involved in defect evasion. Hence, the information is not limited to the inter-defective sector radius dR and the inter-defective sector phase θ, and may be any information that can determine a correction speed that will be described later.

The evasion-orbit defining unit 7 generates a speed-correcting value (correction command amount) V2 from the outputs of the defect-approach determining unit 6, i.e., the inter-defective sector radius dR and the inter-defective sector phase θ. In the target-orbit defining unit 30, the speed control unit (Cv) 3 receives the desired speed Vd corrected in accordance with the speed-correcting value (correction command amount) V2 and outputs a model input value (model-drive command value) Um.

(Defect Evasion)

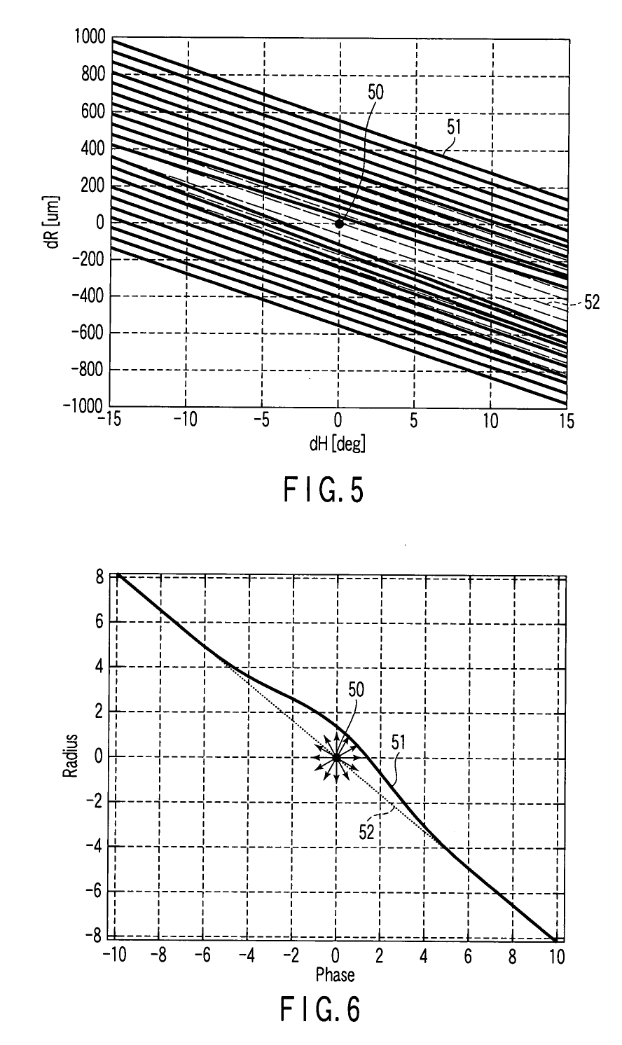

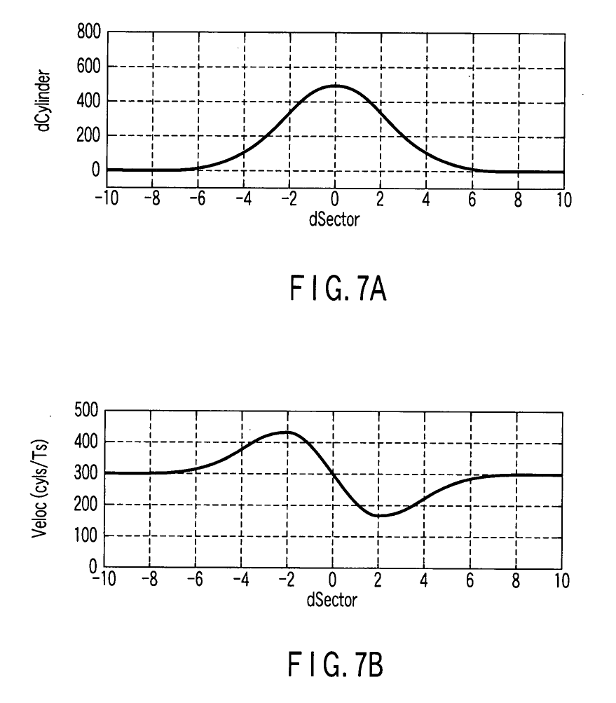

The defect evasion performed in this embodiment will be explained, with reference to FIG. 5, FIG. 6 and FIGS. 7A and 7B. First, the principle of the defect evasion will be described, with reference to FIG. 6 and FIGS. 7A and 7B.

In the disk drive, the locus (seek locus), in which the head 12 moves during the seeking operation, is a spiral one on the surface of the disk medium 11 because the disk medium 11 is rotated at a constant speed. If simplified, the orbit becomes a locus that extends slantwise in a rectangular disk surface as is illustrated in FIG. 6. In FIG. 6, the defective part 50 that should be evaded is located in the center. The dotted line in FIG. 6 indicates the seek orbit in which the head 12 moves, not evading the defective part 50.

A method of evading the defective part 50 may be devised, in which this seek orbit is inferred beforehand and the seeking start timing is changed if the head 11 is likely to pass over the defective part 50. However, the seek orbit can hardly be predicted at once, particularly in a long-distance seeking operation, to say nothing of a short-distance seeking operation. Inevitably it is very difficult to predict when the head 12 will pass over the defective part 50, and to change the seeking start timing correctly.

It is therefore useful to increase or decrease the seeking speed appropriately, while determining whether the head 12 passes near the defective part 50, thereby to evade the defective part 50. In the method of evading the defective part 50, according to the present, the defective part 50 is regarded as generating an external force acting in the radial direction of the disk medium 11, and the seek orbit is considered as having been distorted by the external force.

The direction of rotation of the disk medium can hardly be controlled. It is therefore useful to assume a reaction that is inversely proportional to the distance from the defective part 50 and to distort the target orbit for seeking such a virtual reaction (i.e., reaction inversely proportional to the square of that distance). The defective part 50 may lie close to the orbit of the magnetic head 12 and accordingly influences the orbit greatly. In this case, the virtual reaction thus set distorts the orbit very much. If the defective part 50 lies relatively far from the orbit of the magnetic head 12, the orbit will be so corrected to achieve almost no defect evasion.

Solid line 51 shown in FIG. 6 represents a defect-evading orbit. The defect-evading orbit has been defined by first forming a corrected orbit model in which the mass points connected by springs and dampers move due to a virtual reaction applied from the defective part 50, and then adding this corrected orbit model to a target orbit 52. FIG. 7A is a graph showing a position-correcting amount applied to the defect-evading orbit model 51. 7B is a graph showing a speed-correcting amount applied to the defect-evading orbit model 51.

The defect evasion according to this embodiment, which is based on the above-mentioned principle, will be explained in detail. The system according to this embodiment has an evasion-orbit defining unit 7. The evasion-orbit defining unit 7 infers the distance between the defective sector and the orbit (seek orbit) not corrected to evade defects is inferred and generates a speed-correcting amount (speed-correcting value) V2 from the reciprocal of the distance inferred.

The evasion-orbit defining unit 7 calculates the speed-correcting value V2, using the following equation (1).

V2=G·{−2αθ·exp(−αθ²)} (1)

In the equation (1),

$$G = \frac{β}{dR - 0 \cdot ( 1 - {z}^{- 1} ) dR}$$

where α is a constant that corresponds to an evasion-detecting sensitivity range and β is the gain constant that determines a preset evasion amount.

The equation (1) differs from the equation for finding an orbit-correcting amount defined by the springs, damper model and virtual reaction that have been explained in conjunction with the principal of the defect evasion. Nonetheless, this differential equation is used because the manner of evading the defect, indicated by the solid line 51 in FIG. 6 is similar to the Gauss function. That is, the equation (1) is used as a modification of the following equation (2).

$$y = exp ( - {x}^{2} ) , \\ \frac{d y}{d x} = - 2 x \cdot exp ( - {x}^{2} ) \qquad ( 2 )$$

As seen from the equation (1), an exponential operation must be performed to calculate the speed-correcting value V2. Thus, the evasion-orbit defining unit 7 is designed to refer to a table in accordance with the inter-defective sector phase θ. The inter-defective sector phase θ does not have an integer value because a fatal defective sector exists between servo sectors. However, since the defective sector is managed as existing at the nearest servo-sector position, the unit 7 needs to refer to the table.

Gain G that determines the correction amount is obtained as a reciprocal of the distance between the defective part and the orbit inferred from the target position (virtual model position) Pr. The distance between the defective part and the orbit thus inferred should be obtained essentially as two-dimensional information. Nonetheless, the distance can be regarded as a one-dimensional quantity in the radial direction. This is because the track pitch is shorter than the one-servo-track distance by some digits of magnitude. The distance L between the orbit and the defective part, as measured in the radial direction, is given by using the following equation (3).

L=dR−Vr·Tc (3)

where Tc is time to reach a defective sector.

As can be understood from the equation (3), the distance L is the distance between the defective part and the nearest position the head 12 may have with respect to the defective part. The present model speed Vr is not information given from the defect-approach determining unit 6, but can be inferred as a difference from the inter-defective sector radius dR for the immediately preceding sample. In the equation (1), the present model speed Vr is gain G that is a proportional multiple of 1/L. Since 1/L is rounded off to an integer value, the gain G that determines the evasion amount will be zero if the predicted approach distance L from the orbit of the head 12 is equal to or longer than a particular value. In this case, the speed-correcting value V2 will be zero.

As described above, the speed-correcting value V2 can be calculated by using the equation (1). The speed control unit (Cv) 3 receives the sum of the speed-correcting value V2 and the desired speed Vd generated by the speed-profile generating unit (Pv) 2 and outputs a model input value (model-drive command value) Um. Thus, the speed control unit (Cv) 3 generates a defect-evading orbit for the target position (virtual model position) Pr.

FIG. 5 is a graph illustrating a simulated defect evasion according to the present embodiment. In the figure, the broken lines 52 indicate seek orbit observed when no defect evasion is performed. The solid lines 51 indicates the seek orbit observed when the defect evasion is performed. These solid lines 51 represent 11 seek patterns that extend near the defective part 50.

As confirmed from FIG. 5, the acceleration and the deceleration are automatically switched from one to the other during the seeking control in accordance with where in the predicted orbit the defective part 50 exists, and the head 12 moves, reliably evading the defective part 50. It is confirmed from FIG. 5, too, that the defect evasion is not performed in any seeking operation at a position relatively remote from the defective part 50.

Nonetheless, the speed control unit 3 applies the model input value Um in order to prevent the drive command value from saturating. The speed-profile generating unit 2 changes the desired position Pd in accordance with the target position (virtual model position) Pr. This is why the head 12 has not returned to the initial orbit as explained in conjunction with the principle of the defect evasion. This means that the change in the seek time will increase. Nevertheless, the defect evasion at this point delays or advances the seeking operation by a few samples only. Hence, the resulting degradation in the disk drive performance is negligibly small.

In the defect evading unit 5 according to this embodiment, the defect-approach determining unit 6 extracts one defective sector and then performs the defect evasion. Instead, the unit 6 may be configured to extract a plurality of defective sectors at the same time and then perform the defect evasion, if conditions have been set to achieve linear addition.

(Defect Evasion During the Tracking Operation)

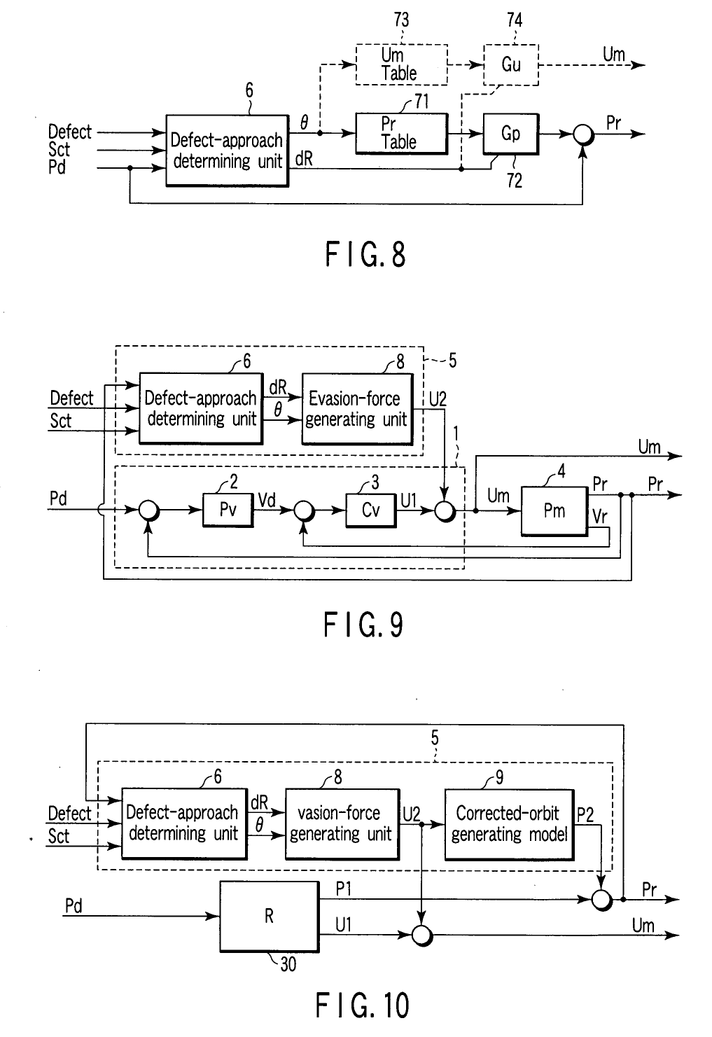

How the defect evasion is performed during the tracking operation will be explained, with reference to FIG. 8.

In the disk drive, any track having fatal defective sectors is registered as a defective track, and the tracks or sectors adjacent to such track are also registered as defective tracks. Measures are thus taken to prevent other defects from developing.

More specifically, data is neither read from, nor written in, any sector near the track having fatal defective sectors. However, a read or write command may be made, in some cases, for the data sectors existing in any track other than the defective track and, thus, being other than the data sectors registered as defective ones. Generally, the slider that supports the head 12 is much broader than the track pitch. Defective parts of the disk medium 11 may therefore lie below the slider, if not below the head 12.

It is therefore important to evade the defective parts in not only the seeking operation but also the tracking operation. The defect evasion during the tracking operation can be exactly the same as the defect evasion during the seeking operation, nevertheless. A defect evasion performed during the tracking operation, which differs from the defect evasion performed during the seeking operation, will be explained below.

FIG. 8 shows a target-orbit defining unit that defines a target orbit for the tracking operation. To define a target orbit the tracking operation, a table is searched for a simple evasion pattern, and a proportional multiple of the simple evasion pattern is obtained and applied, thereby correcting the position at which to move the head. The defect-approach determining unit 6 works basically in the same way as in the seeking operation, but it receives not the present target position (model position) Pr, but the position Pd desired at present. The unit 6 extracts the defect-position information showing the position of the nearest defect. Then, the unit 6 generates and outputs an inter-defective sector phase θ and an inter-defective sector radius dR.

A corrected-position referring unit (Pr table) 71 refers to a table of patterns registered in association with various servo sector differences (i.e., inter-defective sector phase θ), and outputs a defect-evasion pattern. The defect-evasion pattern thus output may be such a pattern as shown in FIG. 7A. A corrected-position amplitude adjusting unit (Gp) 72 amplifies the defect-evasion pattern with gain Gp that is inversely proportional to the inter-defective sector radius dR. The unit 72 adds the defect-evasion pattern to the desired position Pd, generating a target position (model position) Pr.

The processes described above change the target position for each servo sector. The head 12 can therefore follow the target position with a sufficiently high precision, by using the conventional servo system. The position Pos of the head can be almost identical to the target position (model position) Pr, and the defect evasion can be accomplished. The inter-defective sector phase θ may be attained by referring to the defect-evasion pattern. In this case, the head does not move to the desired position Pd. The data reading and data writing are then inhibited. The data reading and data writing can be performed after the defect-evasion pattern has been referred to.

In FIG. 8, blocks 73 and 74 are not absolutely necessary. Gu is a gain defined as a function of dR, like the gain Gp.

As has been described, the head is controlled not to move over any defective part on the disk medium, or to evade such a defective part. This prevents undesirable events such as a post defect.

### Other Embodiment

FIGS. 9 and 10 are block diagrams of a target-orbit defining unit according to another embodiment of this invention, which is designed to define a target orbit for the seeking operation.

FIG. 10 is a block diagram showing the basic configuration of the target-orbit defining unit that defines an orbit in which the head should move to to evade any defect. In the basic configuration, the defect-evading unit 5 has a defect-approach determining unit 6, an evasion-force generating unit 8, and a corrected-orbit generating model 9. Two virtual model systems 8 and 9 that generate correction values for achieving defect evasion are arranged outside the target-orbit defining unit 30.

The target-orbit defining unit for defining an orbit in which the head should move to to evade any defect generates two outputs. One output is Pr, which is the sum of the output P1 of the target-orbit defining unit 30 and the output P2 of the virtual model system 9. The other output is Um, which is the sum of the output U1 of the target-orbit defining unit 30 and the output U2 of the virtual model system 8. FIG. 9 shows a modification of the basic configuration shown in FIG. 10.

As has been described, the head 12 can be controlled in the embodiments described above, not to move over defective parts, if any on the disk medium 11, or to move, evading the defective parts, during the seeking operation and the tracking operation. This can prevent post defects, such as expansion of any defective part and damage to the head 12.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a head-moving mechanism which moves a head to a desired position on a rotating disk medium;
a head-motion control unit which defines, for each sampling time, a motion orbit of the head, extending to the desired position from the position the head takes at present, thereby controlling the head-moving mechanism;
a storage unit which stores defect position information representing the position of a defective part existing on the disk medium;
a determining unit which determines, in each sampling time, the position of the head approaching the defective part, from the defect position information, while the head is being moved toward the desired position by the head-moving mechanism; and
an evasion unit which changes the motion orbit of the head on the basis of the position determined by the determining unit, thereby making the head evade the defective part.

2. The disk drive according to claim 1, wherein the head-motion control unit is constituted by a model-following control system; and the evasion unit is configured to make a virtual model position evade the defective part.

3. The disk drive according to claim 1, wherein the head-motion control unit is configured to perform a seeking control by means of a model-following control method; the determining unit calculates a distance from a servo sector to a defective sector in a radial direction and a distance in a circumferential direction, which is an inter-defective sector phase, on the basis of the virtual model position, the servo sector at which the head lies at present and the defect position information; and the evasion unit is configured to correct, on the basis of the distances calculated by the determining unit, a model-drive command value that is a virtual-model input value, thereby making the virtual model position evade the defective part.

4. The disk drive according to claim 1, wherein the evasion unit is configured to generate a corrected-orbit generating model based on a virtual reaction emanating from the defective part, thereby changing the motion orbit of the head.

5. The disk drive according to claim 1, wherein the head-motion control unit is configured to perform a seeking control by means of a model-following control method; the determining unit is configured to calculate the distance to a defective part near the position that the head has at present in the direction the head moves and a seeking operation proceeds; and the evasion unit is configured to generate a defect-evasion speed on the basis of the distance calculated by the determining unit and to output the defect-evasion speed as a speed-correcting value for the speed of the seeking operation.

6. The disk drive according to claim 1, wherein the head-motion control unit is configured to perform a seeking control by means of a model-following control method; the determining unit is configured to calculate the distance to a defective part near the position that the head has at present in the direction the head moves and a seeking operation proceeds; the evasion unit is configured to generate a defect-evasion speed on the basis of the distance calculated by the determining unit and to output the defect-evasion speed as a speed-correcting value for the speed of the seeking operation; and the head-motion control unit incorporates a speed-generating unit which converts a speed value corrected with the speed-correcting value, to a virtual-model input value and which outputs the virtual-model input value as a virtual model command.

7. The disk drive according to claim 1, wherein the head-motion control unit is configured to perform a seeking control by means of a model-following control method; and the evasion unit is configured to generate corrected position information which makes a virtual model position evade the defective part.

8. The disk drive according to claim 1, wherein the determining unit detects the defective part from the defect position information and determines a position to which the head has approached the defective part; and the evasion unit is configured to change the motion orbit of the head on the basis of a virtual reaction emanating from the defective part, thereby making the head evade the defective part.

9. The disk drive according to claim 1, wherein the head-motion control unit is constituted by a microprocessor which is configured to perform a seeking control by means of a model-following control method.

10. The disk drive according to claim 1, wherein the determining unit and the evasion units are constituted by a microprocessor.

11. A method of controlling a motion of a head comprising a head-moving mechanism which moves a head to a desired position on a rotating disk medium, and a head-motion control unit which defines a motion orbit of the head, extending to the desired position from the position the head takes at present, thereby controlling the head-moving mechanism, the method comprising:
determining the position of the head approaching the defective part, from the defect position information, while the head is being moved toward the desired position by the head-moving mechanism; and
performing a defect-evading process of changing the motion orbit of the head on the basis of the position determined, thereby making the head evade the defective part.
